(19) United States
(12) Patent Application Publication
(10) Pub. No.: US 2026/0278926 A1
(43) Pub. Date: Sep. 17, 2026

(54) GENERATION DEVICE AND GENERATION METHOD

(71) Applicant: IHI Corporation, Tokyo (JP)

(72) Inventors: Takahisa OSHIMA, Tokyo (JP); Yoshino FUJII, Tokyo (JP); Tomohiro NAKAGAWA, Tokyo (JP); Kazumasa SUZUKI, Tokyo (JP)

(73) Assignee: IHI Corporation, Tokyo (JP)

(21) Appl. No.: 19/679,087

(22) Filed: May 15, 2026

Related U.S. Application Data
(63) Continuation of application No. PCT/JP2024/039562, filed on Nov. 7, 2024.

(30) Foreign Application Priority Data
Nov. 22, 2023 (JP) 2023-198454

(51) Int. Cl. G06T 17/00; G06T 7/00; G06T 19/20

(52) U.S. Cl. CPC G06T 17/00; G06T 7/0004; G06T 19/20; G06T 2207/20081

(57) ABSTRACT

An image processing device (generation device) includes: a 3D graphic model generating unit (virtual object generating unit) that generates a virtual object representing a three-dimensional shape of an inspection object in a virtual space on the basis of three-dimensional shape data of the inspection object; a defect adding unit that adds a defect to the virtual object; a 3DCG image generating unit that generates at least three 3DCG images with different virtual light sources on the basis of the virtual object to which the defect has been added, at least three virtual light sources that illuminate the virtual object to which the defect has been added, and a virtual imaging device that captures an image of the virtual object being illuminated; and a first image generating unit that generates a first image as training data on the basis of a direction vector of a surface of the virtual object derived on the basis of the at least three 3DCG images.

### CROSS REFERENCE TO RELATED APPLICATIONS

This application is a continuation application of International Application No. PCT/JP2024/039562, filed on Nov. 7, 2024, which claims priority to Japanese Patent Application No. 2023-198454, filed on Nov. 22, 2023, the entire contents of which are incorporated by reference herein.

### BACKGROUND ART

### Technical Field

The present disclosure relates to a generation device and a generation method. The present application claims the benefit of priority based on Japanese Patent Application No. 2023-198454 filed on Nov. 22, 2023, the content of which is incorporated herein.

### Related Art

In the related art, appearance inspection of an inspection object using an imaging device is performed. In the appearance inspection, a captured image captured by the imaging device is input to a deep learning model (hereinafter, it is also referred to as an inspection model) trained in advance, and the position of a defect that is an abnormal part of the inspection object can be obtained as output.

Patent Literature 1 discloses technology in which a light source and an inspection object are virtually arranged in a virtual space, and images generated by simulation by a computer are used as training data. In the technology described in Patent Literature 1, an inspection model for appearance inspection of an inspection object is trained using training data, and a captured image of the inspection object is given to the trained inspection model, whereby the quality of the appearance of the inspection object can be automatically determined.

### CITATION LIST

### Patent Literature

Patent Literature 1: JP 2019-215240 A

### SUMMARY

### Technical Problem

However, in a case where an image generated by simulation is compared with a captured image captured by a real imaging device, there is a large difference in appearance between the two images. This is because it is difficult to match the surface optical characteristics of the actual inspection object with the surface optical characteristics of the inspection object in the simulation regarding the surface optical characteristics that determine the appearance such as the specular reflectance and the diffuse reflectance of the material of the inspection object.

Therefore, even when an image generated by simulation is used as training data as in Patent Literature 1, there is a problem that the accuracy of the position of the defect in the inspection object estimated by the inspection model trained using the training data is poor.

The object of the present disclosure is to provide a generation device and a generation method of training data capable of improving the accuracy of an estimated position of a defect of an inspection object in consideration of the above problem.

### Solution to Problem

In order to solve the above problem, a generation device according to one aspect of the present disclosure includes: a virtual object generating unit that generates a virtual object representing a three-dimensional shape of an inspection object in a virtual space on the basis of three-dimensional shape data of the inspection object; a defect adding unit that adds a defect to the virtual object; a 3DCG image generating unit that generates at least three 3DCG images with different virtual light sources on the basis of the virtual object to which the defect has been added, at least three virtual light sources that illuminate the virtual object to which the defect has been added, and a virtual imaging device that captures an image of the virtual object being illuminated; and a first image generating unit that generates a first image as training data on the basis of a direction vector of a surface of the virtual object derived on the basis of the at least three 3DCG images.

A captured image generating unit that generates at least three captured images with different light sources on the basis of the inspection object, at least three light sources that illuminate the inspection object, and an imaging device that captures an image of the inspection object being illuminated and a second image generating unit that generates a second image as the training data on the basis of a direction vector of a surface of the inspection object derived on the basis of the at least three captured images may be further included, and the three light sources may be arranged at positions corresponding to positions of the three respective virtual light sources.

The training data may be data in which correct data indicating the position of the defect is associated with the first image.

In order to solve the above problem, a generation method according to one aspect of the present disclosure includes the steps of: generating a virtual object representing a three-dimensional shape of an inspection object in a virtual space on the basis of three-dimensional shape data of the inspection object; adding a defect to the virtual object; generating at least three 3DCG images with different virtual light sources on the basis of the virtual object to which the defect has been added, at least three virtual light sources that illuminate the virtual object to which the defect has been added, and a virtual imaging device that captures an image of the virtual object being illuminated; and generating a first image as training data on the basis of a direction vector of a surface of the virtual object derived on the basis of the at least three 3DCG images.

### Effects

According to the present disclosure, the accuracy of an estimated position of a defect of an inspection object can be improved.

### BRIEF DESCRIPTION OF DRAWINGS

FIG. 1 is a schematic configuration diagram of an inspection system according to the present embodiment.

FIG. 2 is a schematic block diagram of the inspection system according to the embodiment.

FIG. 3 is a block diagram illustrating an example of a functional configuration of an image processing device according to the embodiment.

FIG. 4 is a schematic configuration diagram illustrating an example of a 3D graphic model generated in a virtual space.

FIG. 5 is a diagram illustrating an example of a first 3DCG image.

FIG. 6 is a diagram illustrating an example of a second 3DCG image.

FIG. 7 is a diagram illustrating an example of a third 3DCG image.

FIG. 8 is a diagram illustrating an example of a first image.

FIG. 9 is an explanatory diagram for explaining a direction vector of a surface of an inspection object illuminated by light from a first virtual light source.

FIG. 10 is an explanatory diagram for explaining a direction vector of the surface of the inspection object illuminated by light from a second virtual light source.

FIG. 11 is an explanatory diagram for explaining a direction vector of the surface of the inspection object illuminated by light from a third virtual light source.

FIG. 12 is a diagram illustrating an example of an inspection model.

FIG. 13 is a flowchart illustrating an example of a generation method of training data according to the present embodiment.

FIG. 14 is a diagram illustrating examples of a captured image obtained by capturing an inspection object with all of a plurality of light sources turned on and a 3DCG image obtained by capturing a virtual object with all of the plurality of virtual light sources turned on.

FIG. 15 is a diagram illustrating examples of a normal map image generated by sequentially turning on the plurality of light sources for the inspection object and a normal map image generated by sequentially turning on the plurality of virtual light sources for the virtual object.

### DESCRIPTION OF EMBODIMENTS

Embodiments of the present disclosure will be described in detail below with reference to the accompanying drawings. Specific dimensions, materials, numerical values, and others illustrated in such embodiments are merely examples for facilitating understanding, and the present disclosure is not limited thereby except for a case where it is specifically mentioned. Note that, in the present specification and the drawings, components having substantially the same function and structure are denoted by the same symbol, and redundant explanations are omitted. Illustration of components not directly related to the present disclosure is omitted.

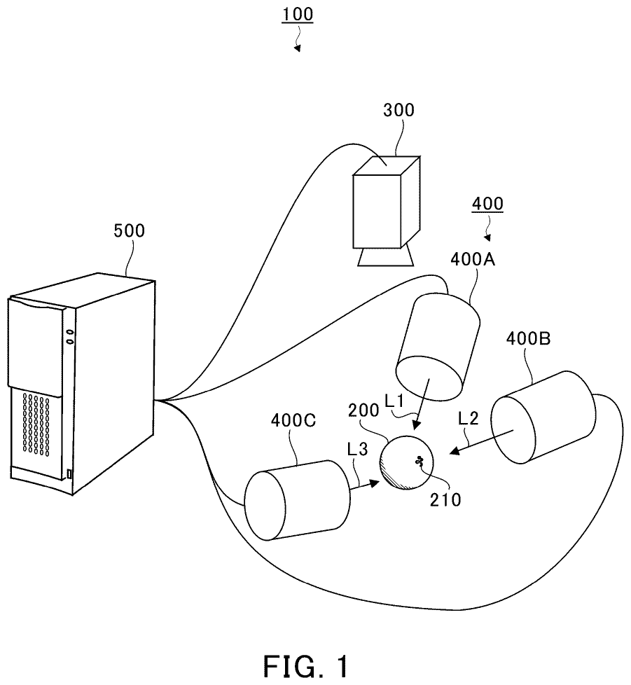

FIG. 1 is a schematic configuration diagram of an inspection system 100 according to the present embodiment. The inspection system 100 is a system for performing an appearance inspection on an inspection object 200. As illustrated in FIG. 1, the inspection system 100 includes one imaging device 300, a plurality of light sources 400, and an image processing device 500.

The inspection object 200 is a real product which is disposed in a real space and whose appearance inspection is performed by the inspection system 100. In the present embodiment, the inspection object 200 is, for example, a general industrial product. However, the inspection object 200 is not limited to an industrial product as long as an image of which can be captured by the imaging device 300.

In the present embodiment, the inspection object 200 may partially include a defect 210 which is an abnormal portion. The defect 210 is formed on a part of the surface of the inspection object 200, and is, for example, a protrusion or a dent formed on the surface of the inspection object 200. The defect 210 of the inspection object 200 occurs, for example, when the inspection object 200 is thinned due to corrosion, when a foreign substance has entered during pressing of the inspection object 200, or when a tool collides with the surface of the inspection object 200.

The imaging device 300 is an actual camera arranged in a real space. The camera viewpoint of the imaging device 300 is located, for example, above the inspection object 200, and the imaging direction of the imaging device 300 is, for example, a downward direction toward the inspection object 200. In the present embodiment, the imaging device 300 images the inspection object 200 from above. However, it is not limited thereto, and the imaging device 300 may capture an image of the inspection object 200 from below or from a side.

The imaging device 300 images the inspection object 200 and generates a captured image of the inspection object 200. The imaging device 300 outputs the generated captured image of the inspection object 200 to the image processing device 500. In the present embodiment, one imaging device 300 is disposed for one inspection object 200. One imaging device 300 is disposed facing the inspection object 200 such that the inspection object 200 is included in the imaging range. A plurality of captured images of the inspection object 200 is captured while the position of the imaging device 300 is fixed.

The plurality of light sources 400 includes at least three light sources. The reason for using at least three light sources is to capture an image of the inspection object 200 by a photometric stereo method. The photometric stereo method is one of three-dimensional measurement methods in which images obtained by illuminating the inspection object 200 from a plurality of different illumination directions are captured, and a normal vector, which is a direction vector of a surface of the inspection object 200, is obtained from shadow and shade information thereof. Incidentally, the normal vector is a vector in a direction perpendicular to the surface of the inspection object 200. The photometric stereo method is also called illuminance difference stereo method.

The plurality of light sources 400 include a first light source 400A, a second light source 400B, and a third light source 400C. The first light source 400A illuminates the inspection object 200 from a first direction L1. The second light source 400B illuminates the inspection object 200 in a second direction L2 different from the first direction L1. The third light source 400C illuminates the inspection object 200 in a third direction L3 different from the first direction L1 and the second direction L2. With the positions of the first light source 400A, the second light source 400B, and the third light source 400C fixed, the inspection object 200 is illuminated with light emitted from any one of the first light source 400A, the second light source 400B, or the third light source 400C.

The first light source 400A, the second light source 400B, and the third light source 400C are actual light sources arranged in the real space. The first light source 400A, the second light source 400B, and the third light source 400C are arranged at intervals of 90° such as 0°, 90°, and 180° in the circumferential direction of the inspection object 200. However, it is not limited thereto, and the first light source 400A, the second light source 400B, and the third light source 400C may be arranged at equal intervals of 120° such as 0°, 120°, and 240° in the circumferential direction of the inspection object 200. Note that, in a case where the plurality of light sources 400 includes four light sources, the four light sources may be arranged at equal intervals of 90° such as 0°, 90°, 180°, and 270° in the circumferential direction of the inspection object 200.

As described above, the first light source 400A, the second light source 400B, and the third light source 400C illuminate the inspection object 200 from different directions. In the present embodiment, the number of the plurality of light sources 400 is three. However, the number of the plurality of light sources 400 is only required to be at least three or more, and is not limited to three.

The image processing device 500 is electrically connected with the imaging device 300 and the plurality of light sources 400, and controls the imaging device 300 and the plurality of light sources 400. The image processing device 500 controls the imaging device 300 and the plurality of light sources 400 to illuminate the inspection object 200 from at least three different illumination directions at different timing of at least three types in order to capture an image of the inspection object 200 by the photometric stereo method.

Specifically, the image processing device 500 causes the first light source 400A to emit light toward the inspection object 200 in the first direction L1 at first timing, and performs control to acquire a first captured image of the illuminated inspection object 200. In addition, the image processing device 500 causes the second light source 400B to emit light toward the inspection object 200 in the second direction L2 at second timing different from the first timing, and performs control to acquire a second captured image of the illuminated inspection object 200. The second timing is, for example, timing after the first timing. In addition, the image processing device 500 causes the third light source 400C to emit light toward the inspection object 200 in the third direction L3 at third timing different from the first timing and the second timing, and performs control to acquire a third captured image of the illuminated inspection object 200. The third timing is, for example, timing after the second timing.

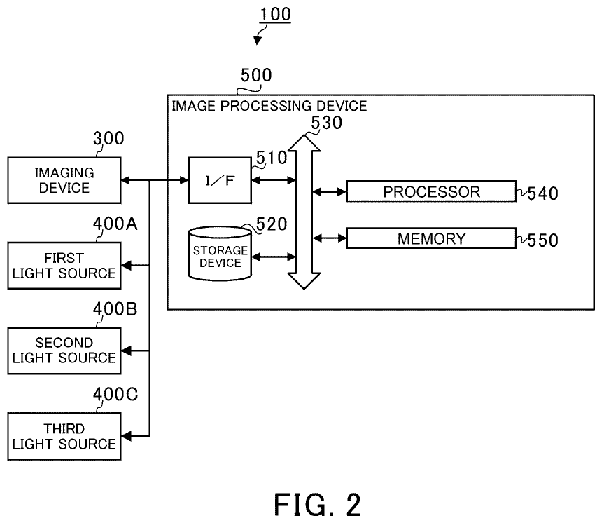

FIG. 2 is a schematic block diagram of the inspection system 100 according to the embodiment. As illustrated in FIG. 2, the image processing device 500 includes an I/F 510, a storage device 520, a system bus 530, one or more processors 540, and one or more memories 550. The I/F 510 is an interface for communicating with the imaging device 300, the first light source 400A, the second light source 400B, and the third light source 400C. Note that the image processing device 500 according to the present embodiment also functions as a generation device that generates training data as described later in detail.

The storage device 520 includes a RAM, a flash memory, an HDD, and the like, and holds various types of information necessary for processing by the processor 540 described below. Specifically, the storage device 520 stores three-dimensional shape data of the inspection object 200 and a defect 610 given to a virtual object 600 described later. The three-dimensional shape data represents the three-dimensional shapes of the inspection object 200 and the defect 610, is represented by a polygon mesh, and has information of coordinates in a three-dimensional space. The three-dimensional shape data of the present embodiment is, for example, 3D CAD data. However, the three-dimensional shape data is not limited thereto, and may be 3D data obtained by measuring the inspection object 200 and the defect 210 using a three-dimensional optical measuring instrument such as a laser displacement meter or a stereo imaging device, an X-ray CT device, or the like.

The system bus 530 is a transmission path that electrically connects the I/F 510, the storage device 520, the processor 540, and the memory 550 and transmits data therebetween.

The processor 540 includes, for example, a central processing unit (CPU). The memory 550 includes, for example, a read only memory (ROM), a random access memory (RAM), and the like. The ROM is a storage element that stores programs, operation parameters, and the like used by the CPU. The RAM is a storage element that temporarily stores data such as variables and parameters used for processing executed by the CPU.

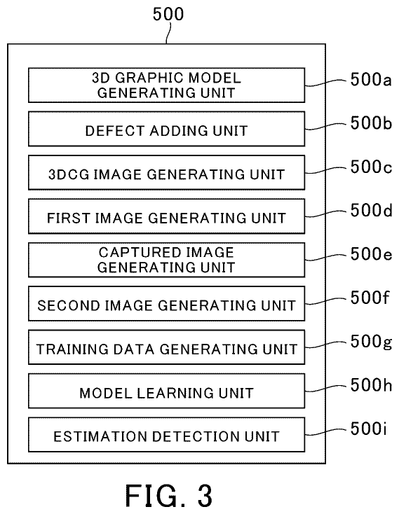

FIG. 3 is a block diagram illustrating an example of a functional configuration of the image processing device 500 according to the embodiment. For example, as illustrated in FIG. 3, the image processing device 500 includes a 3D graphic model generating unit (virtual object generating unit) 500a, a defect adding unit 500b, a 3DCG image generating unit 500c, a first image generating unit 500d, a captured image generating unit 500e, a second image generating unit 500f, a training data generating unit 500g, a model learning unit 500h, and an estimation detection unit 500i.

The processor 540 illustrated in FIG. 2 cooperates with a program included in the memory 550 and executes the program included in the memory 550. As a result, various types of processing including processing described below and performed by the 3D graphic model generating unit 500a, the defect adding unit 500b, the 3DCG image generating unit 500c, the first image generating unit 500d, the captured image generating unit 500e, the second image generating unit 500f, the training data generating unit 500g, the model learning unit 500h, and the estimation detection unit 500i are implemented.

On the basis of the three-dimensional shape data of the inspection object 200 stored in the storage device 520, the 3D graphic model generating unit 500a generates the virtual object 600, which is a 3D graphic model representing the three-dimensional shape of the inspection object 200 in a virtual space S. The position and the orientation of the virtual object 600 imitating the inspection object 200 disposed in the virtual space S are set to be the same as the position and the orientation of the actual inspection object 200 illustrated in FIG. 1.

Furthermore, the 3D graphic model generating unit 500a sets the position and the imaging direction of the camera viewpoint of a virtual imaging device 700 in the virtual space S. At this point, the position and the imaging direction of the camera viewpoint of the virtual imaging device 700 are set to be the same as the camera viewpoint and the imaging direction of the actual imaging device 300 illustrated in FIG. 1.

In addition, the 3D graphic model generating unit 500a sets the position and the irradiation direction of the first virtual light source 800A in the virtual space S. At this point, the position and the irradiation direction of the first virtual light source 800A are set to be the same as the position and the irradiation direction of the actual first light source 400A illustrated in FIG. 1. The 3D graphic model generating unit 500a sets the position and the irradiation direction of the second virtual light source 800B in the virtual space S. At this point, the position and the irradiation direction of the second virtual light source 800B are set to be the same as the position and the irradiation direction of the actual second light source 400B illustrated in FIG. 1. The 3D graphic model generating unit 500a sets the position and the irradiation direction of the third virtual light source 800C in the virtual space S. At this point, the position and the irradiation direction of the third virtual light source 800C are set to be the same as the position and the irradiation direction of the actual third light source 400C illustrated in FIG. 1. The first virtual light source 800A, the second virtual light source 800B, and the third virtual light source 800C are also collectively referred to as a plurality of virtual light sources 800.

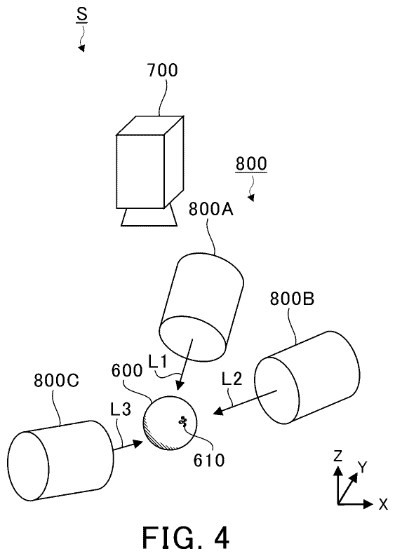

FIG. 4 is a schematic configuration diagram illustrating an example of a 3D graphic model generated in the virtual space S. In FIG. 4, the X direction, the Y direction, and the Z direction are orthogonal to each other. The X direction and the Y direction are horizontal directions, and the Z direction is a vertical direction. As illustrated in FIG. 4, the virtual object 600 imitating the inspection object 200, the virtual imaging device 700 imitating the imaging device 300, and a plurality of virtual light sources 800 imitating the plurality of light sources 400 are arranged in the virtual space S. Note that the plurality of virtual light sources 800 include at least three virtual light sources in order to capture an image of the virtual object 600 imitating the inspection object 200 by the photometric stereo method.

In the XYZ coordinates in the virtual space S, the virtual object 600 is disposed at a position corresponding to the inspection object 200 illustrated in FIG. 1. Furthermore, in the XYZ coordinates in the virtual space S, the virtual imaging device 700 is disposed at a position corresponding to the imaging device 300 illustrated in FIG. 1. In the XYZ coordinates in the virtual space S, the first virtual light source 800A is disposed at a position corresponding to the first light source 400A illustrated in FIG. 1. In the XYZ coordinates in the virtual space S, the second virtual light source 800B is disposed at a position corresponding to the second light source 400B illustrated in FIG. 1. In the XYZ coordinates in the virtual space S, the third virtual light source 800C is disposed at a position corresponding to the third light source 400C illustrated in FIG. 1.

In the present embodiment, the virtual imaging device 700 is disposed on an extension line in the +Z direction with respect to the virtual object 600. The first virtual light source 800A is disposed on the +Y direction side with respect to the virtual object 600. At this point, the first direction L1 in which the light of the first virtual light source 800A is emitted is inclined by −45° to the −Y direction and to the −Z side with respect to the horizontal direction with the position of the first virtual light source 800A set as a reference position. In other words, the first direction L1 is inclined by −45° to the −Y direction and to the −Z side with respect to the horizontal direction with respect to the imaging direction of the virtual imaging device 700. The second virtual light source 800B is disposed on the +X direction side with respect to the virtual object 600. At this point, the second direction L2 in which the light of the second virtual light source 800B is emitted is inclined by −45° to the −X direction and to the −Z side with respect to the horizontal direction with the position of the second virtual light source 800B set as a reference position. In other words, the second direction L2 is inclined by −45° to the −X direction and to the −Z side with respect to the horizontal direction with respect to the imaging direction of the virtual imaging device 700. The third virtual light source 800C is disposed on the −Y direction side with respect to the virtual object 600. At this point, the third direction L3 in which the light of the third virtual light source 800C is emitted is inclined by −45° to the +Y direction and to the −Z side with respect to the horizontal direction with the position of the third virtual light source 800C set as a reference position. In other words, the third direction L3 is a direction inclined by −45° to the +Y direction and to the −Z side with respect to the horizontal direction with respect to the imaging direction of the virtual imaging device 700.

As described above, the virtual object 600 of the present embodiment is disposed such that an image of the virtual object 600 can be captured by the virtual imaging device 700 from immediately above and can be illuminated by the first virtual light source 800A, the second virtual light source 800B, and the third virtual light source 800C at intervals of 90° in the circumferential direction from obliquely above by 45°.

Note that the imaging direction of the imaging device 300 illustrated in FIG. 1 and the first direction L1, the second direction L2, and the third direction L3 of the plurality of light sources 400 are the same as the imaging direction of the virtual imaging device 700 illustrated in FIG. 4 and the first direction L1, the second direction L2, and the third direction L3 of the plurality of virtual light sources 800.

The defect adding unit 500b gives a defect 610 as an abnormal part to the virtual object 600 generated by the 3D graphic model generating unit 500a. Specifically, the defect adding unit 500b forms the defect 610 represented in a three-dimensional shape as a dent on the surface of the virtual object 600.

Three-dimensional shape data of the defect 610 of the dent is generated, for example, by randomly generating a depth distribution with a uniform random number and leveling the depth distribution in such a manner that there is no sudden change such as an edge in the depth distribution. Note that, by applying a window function when generating the data of the defect 610, the boundary portion between the defective portion and the non-defective portion on the surface of the virtual object 600 can be made smooth. By randomly changing the depth distribution of the defect 610, it is possible to easily create three-dimensional shape data of the defect 610 of various patterns.

Specifically, the defect adding unit 500b changes the value corresponding to the depth of each coordinate in the three-dimensional space of the defect 610 on the basis of the probability distribution to randomly generate three-dimensional shape data of the defect 610 different from each other, thereby giving various defects 610 to the virtual object 600. For example, the defect adding unit 500b uses a value corresponding to the depth of each set of coordinates in the three-dimensional space of the defect 610 as a variable, and adds one of values of +a, +0.5a, −0.5a, and −a to the variable to change the variable, thereby generating three-dimensional shape data of each set of coordinates.

Incidentally, a represents a predetermined value, and the defect adding unit 500b changes the value corresponding to the depth of the defect 610 using a probability distribution in which a random variable of ¼ is given to each of +a, +0.5a, −0.5a, and −a. Note that, although the example in which the depth of the defect 610 is changed has been described here, not only the depth but also the position of the defect 610 may be changed. That is, the defect adding unit 500b changes the shape parameter of the defect 610 on the basis of the probability distribution to generate a plurality of types of virtual objects 600 in a wide variety. As a result, a plurality of types of virtual objects 600 having a wide variety of defects 610 are generated.

As described above, the defect adding unit 500b changes the parameter of the defect 610, thereby generating a plurality of types of virtual objects 600 having a wide variety of defects 610. The parameter of the defect 610 refers to values of coordinates in the three-dimensional space of the defect 610, and for example, the position, the depth, the shape, and the like of the defect 610 can be changed by changing the parameter of the defect 610.

The three-dimensional shape data of the defect 610 may be acquired, for example, by measuring the defect 210 such as a dent or a scratch generated in the actual inspection object 200 with a three-dimensional optical measuring instrument such as a laser displacement meter or a stereo imaging device, an X-ray CT device, or the like. As described above, the generated or acquired three-dimensional shape data of the defect 610 is stored in the storage device 520.

The 3DCG image generating unit 500c emits light from one virtual light source among the plurality of virtual light sources 800, virtually captures an image of the virtual object 600 illuminated by the light from the one virtual light source by the virtual imaging device 700, and generates one 3DCG image. Specifically, the 3DCG image generating unit 500c generates a 3DCG image by performing physics-based rendering on the virtual object 600. The physics-based rendering is to calculate a captured image by the virtual imaging device 700 according to the optical laws of the real world such as reflection, transmission, and diffusion. In this manner, the 3DCG image generating unit 500c generates a 3DCG image on the basis of the virtual object 600 to which the defect 610 is added.

The 3DCG image generating unit 500c virtually captures an image of the virtual object 600 by the virtual imaging device 700 while changing the irradiation direction in which light rays from the plurality of virtual light sources 800 are emitted, and generates a plurality of 3DCG images. Specifically, first, the 3DCG image generating unit 500c causes the first virtual light source 800A among the plurality of virtual light sources 800 to emit light, and virtually captures an image of the virtual object 600 illuminated by the light from the first virtual light source 800A by the virtual imaging device 700 to generate a first 3DCG image 710. Next, the 3DCG image generating unit 500c causes the second virtual light source 800B among the plurality of virtual light sources 800 to emit light, and virtually captures an image of the virtual object 600 illuminated by the light from the second virtual light source 800B by the virtual imaging device 700 to generate a second 3DCG image 720. Finally, the 3DCG image generating unit 500c causes the third virtual light source 800C among the plurality of virtual light sources 800 to emit light, and virtually captures an image of the virtual object 600 illuminated by the light from the third virtual light source 800C by the virtual imaging device 700 to generate a third 3DCG image 730.

The first 3DCG image 710, the second 3DCG image 720, and the third 3DCG image 730 are images virtually captured at different timings. Note that the first 3DCG image 710, the second 3DCG image 720, and the third 3DCG image 730 are images virtually captured under the same or similar imaging conditions to those of the first captured image, the second captured image, and the third captured image and by the photometric stereo method.

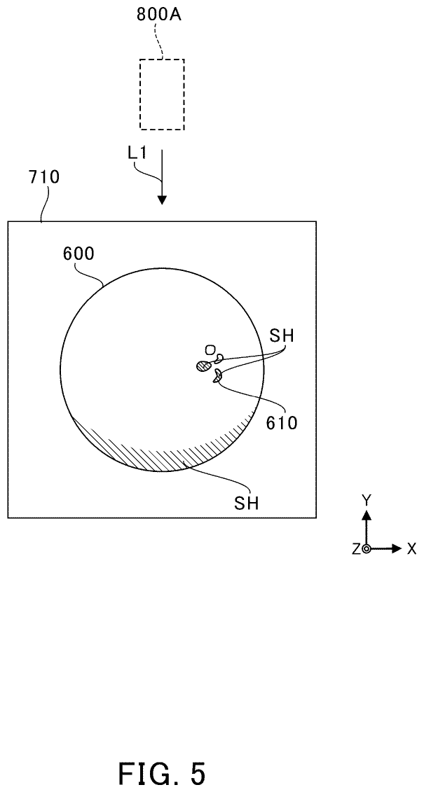

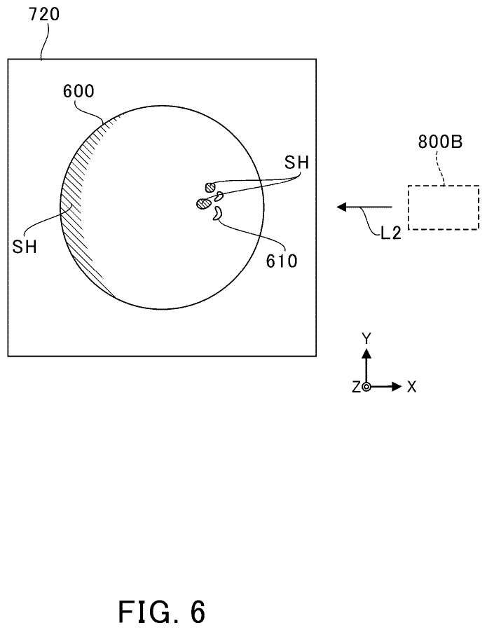

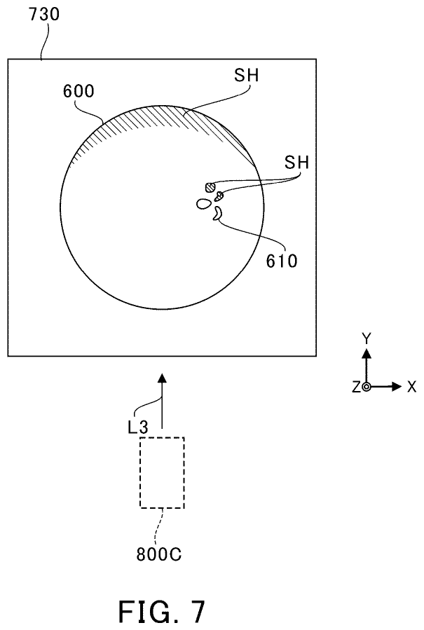

FIG. 5 is a diagram illustrating an example of the first 3DCG image 710. FIG. 6 is a diagram illustrating an example of the second 3DCG image 720. FIG. 7 is a diagram illustrating an example of the third 3DCG image 730. As illustrated in FIGS. 5 to 7, the first 3DCG image 710, the second 3DCG image 720, and the third 3DCG image 730 include images of the virtual object 600 and the defect 610 added on the surface of the virtual object 600.

As illustrated in FIG. 5, the virtual object 600 is illuminated with light emitted from the first virtual light source 800A in the first direction L1. As a result, as illustrated in FIG. 5, a shadow region SH indicated by hatching is formed at an end of the virtual object 600 on the first direction L1 side. In addition, a shadow region SH indicated by hatching is formed inside the dent of the defect 610 on the first direction L1 side. In addition, the inside of the dent of the defect 610 on the side opposite to the first direction L1 side is illuminated with light, and thus no shadow region SH is formed.

As illustrated in FIG. 6, the virtual object 600 is illuminated with light emitted from the second virtual light source 800B in the second direction L2. As a result, as illustrated in FIG. 6, a shadow region SH indicated by hatching is formed at an end of the virtual object 600 on the second direction L2 side. In addition, a shadow region SH indicated by hatching is formed inside the dent of the defect 610 on the second direction L2 side. In addition, the inside of the dent of the defect 610 on the side opposite to the second direction L2 side is illuminated with light, and thus no shadow region SH is formed.

As illustrated in FIG. 7, the virtual object 600 is illuminated with light emitted from the third virtual light source 800C in the third direction L3. As a result, as illustrated in FIG. 7, a shadow region SH indicated by hatching is formed at an end of the virtual object 600 on the third direction L3 side. In addition, a shadow region SH indicated by hatching is formed inside the dent of the defect 610 on the third direction L3 side. In addition, the inside of the dent of the defect 610 on the side opposite to the third direction L3 side is illuminated with light, and thus no shadow region SH is formed.

The first image generating unit 500d generates a first image 740 on the basis of a direction vector of the surface of the virtual object 600 derived on the basis of the first 3DCG image 710, the second 3DCG image 720, and the third 3DCG image 730. Hereinafter, a generation method of the first image 740 will be described in detail.

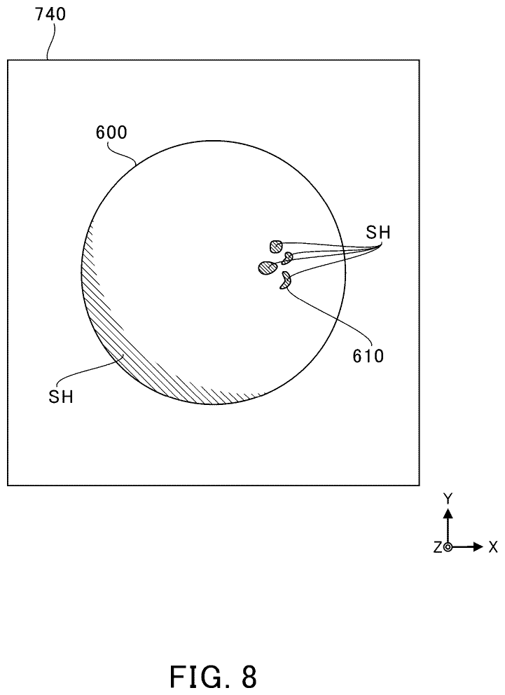

FIG. 8 is a diagram illustrating an example of the first image 740. The first image 740 is an image called a so-called normal map image. A normal map image is an image obtained by deriving a direction vector n of the surface of the inspection object 200 or the virtual object 600 for each pixel of a captured image capturing the inspection object 200 or a 3DCG image capturing the virtual object 600 and visualizing the derived direction vector n as RGB pixel values. The direction vector n of the surface of the inspection object 200 or the virtual object 600 is derived from the following Equations (1). A first method of deriving the direction vector n of the surface of the virtual object 600 to generate the first image 740 as a normal map image is similar to a second method of deriving the direction vector n of the surface of the inspection object 200 to generate a second image as a normal map image. Therefore, in the following, the first method will be described in detail, and description of the second method will be omitted.

$$[ Equations 1 ]$$

$$\begin{matrix}( a 1 ) x + ( a 2 ) y + ( a 3 ) z = A \\ ( b 1 ) x + ( b 2 ) y + ( b 3 ) z = B \\ ( c 1 ) x + ( c 2 ) y + ( c 3 ) z = C\end{matrix} \to n = ( x , y , z ) \qquad ( 1 )$$

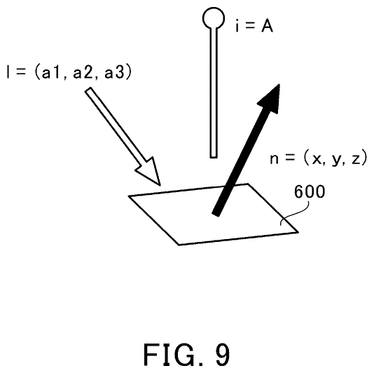

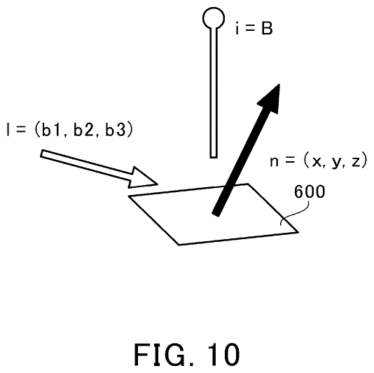

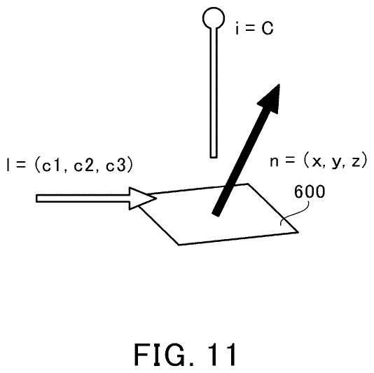

FIG. 9 is an explanatory diagram for explaining the direction vector n of the surface of the virtual object 600 illuminated by the light from the first virtual light source 800A. FIG. 10 is an explanatory diagram for explaining the direction vector n of the surface of the virtual object 600 illuminated by the light from the second virtual light source 800B. FIG. 11 is an explanatory diagram for explaining the direction vector n of the surface of the virtual object 600 illuminated by the light from the third virtual light source 800C.

In FIG. 9, l=(a1, a2, a3) represents the direction vector of the first virtual light source 800A. i=A represents a luminance value which is a pixel value of a pixel in the first 3DCG image 710. n=(x, y, z) represents the direction vector of the surface. The direction vector l of the first virtual light source 800A, the luminance value i, and the direction vector n of the surface have a relationship of i=n·l. That is, the luminance value i is represented by the inner product of the direction vector l of the first virtual light source 800A and the direction vector n of the surface.

In FIG. 10, l=(b1, b2, b3) represents the direction vector of the second virtual light source 800B. i=B represents a luminance value which is a pixel value of a pixel in the second 3DCG image 720. n=(x, y, z) represents the direction vector of the surface. The direction vector l of the second virtual light source 800B, the luminance value i, and the direction vector n of the surface have a relationship of i=n·1. That is, the luminance value i is represented by the inner product of the direction vector l of the second virtual light source 800B and the direction vector n of the surface.

In FIG. 11, l=(c1, c2, c3) represents the direction vector of the third virtual light source 800C. i=C represents a luminance value which is a pixel value of a pixel in the third 3DCG image 730. n=(x, y, z) represents the direction vector of the surface. The direction vector l of the third virtual light source 800C, the luminance value i, and the direction vector n of the surface have a relationship of i=n·l. That is, the luminance value i is represented by an inner product of the direction vector l of the third virtual light source 800C and the direction vector n of the surface.

Since the direction vectors l and the luminance values i of the first virtual light source 800A, the second virtual light source 800B, and the third virtual light source 800C are known, the direction vector n of the surface can be derived by solving the simultaneous equations of the above Equations (1).

In order to generate the normal map image, it is necessary to visualize the direction vector n of the surface derived for each pixel as RGB pixel values. In the present embodiment, the normal map image is derived from the following Expression (2) to Expression (5).

The following Expression (2) is a matrix I in which pixels of the first 3DCG image 710, the second 3DCG image 720, and the third 3DCG image 730 are arranged in lines. In Expression (2), the luminance values of pixels 1 to p of the first 3DCG image 710 are input to img1. The luminance values of pixels 1 to p of the second 3DCG image 720 are input to img2. The luminance values of pixels 1 to p of the third 3DCG image 730 are input to img3. The luminance values input to the pixels 1 to p are values obtained by normalizing a value in a range of 0 to 255 to a value in a range of 0.0 to 1.0.

$$\begin{matrix}[ Expression 2 ] & \\ \begin{matrix} \\ img 1 \\ img 2 \\ img 3\end{matrix} \begin{matrix}\begin{matrix}Pixel 1 & … & Pixel p\end{matrix} \\ ( \begin{matrix}* & … & * \\ * & … & * \\ * & … & *\end{matrix} )\end{matrix} & ( 2 )\end{matrix}$$

The following Expression (3) represents a pseudo inverse matrix L−1 obtained by transforming a matrix L representing the direction vectors of the first virtual light source 800A, the second virtual light source 800B, and the third virtual light source 800C. Note that a case will be described here in which the first direction L1 of the first virtual light source 800A, the second direction L2 of the second virtual light source 800B, and the third direction L3 of the third virtual light source 800C are all inclined to the +Z side by 45° with respect to the horizontal direction with the virtual object 600 used as a reference. However, it is not limited to this, and the first direction L1, the second direction L2, and the third direction L3 may be inclined to the −Z side with respect to the horizontal direction, or may be inclined at an angle other than 45°. Furthermore, although the example in which the matrix L is converted into the pseudo inverse matrix L⁻¹ has been illustrated in the Expression (3), the matrix L may be converted into an inverse matrix.

$$\begin{matrix}[ Expression 3 ] & \\ \begin{matrix} \\ L 1 \\ L 2 \\ L 3\end{matrix} \begin{matrix}\begin{matrix}x & y & z\end{matrix} \\ ( \begin{matrix}cos ( 45 ° ) , & 0. , & sin ( 45 ° ) \\ 0. , & cos ( 45 ° ) , & sin ( 45 ° ) \\ 0. , & - cos ( 45 ° ) , & sin ( 45 ° )\end{matrix} ) \\ Matrix L\end{matrix} ⇒ \begin{matrix}x \\ y \\ z\end{matrix} \begin{matrix}( \begin{matrix}* & … & * \\ * & … & * \\ * & … & *\end{matrix} ) \\ Pseudo \\ inverse matrix {L}^{- 1}\end{matrix} & ( 3 )\end{matrix}$$

The following Equation (4) represents a matrix product L⁻¹·I which is a product of the matrix I of Expression (2) 1 and the pseudo inverse matrix L⁻¹ of Expression (3). Meanwhile, the following Expression (5) represents a result of converting the magnitude of the vector in each pixel of the matrix product of Equation (4) into 1.

$$\begin{matrix}[ Equation 4 ] & \\ \begin{matrix}Pixel 1 & ⋯ & Pixel p\end{matrix} \\ \begin{matrix}x \\ y \\ z\end{matrix} {( \begin{matrix}* & ⋯ & * \\ * & ⋯ & * \\ * & ⋯ & *\end{matrix} )}_{{Pseudo}_{inverse matrix {L}^{- 1}}} \cdot \begin{matrix}img 1 \\ img 2 \\ img 3\end{matrix} {( \begin{matrix}* & ⋯ & * \\ * & ⋯ & * \\ * & ⋯ & *\end{matrix} )}_{Matrix I} = \begin{matrix}Pixel 1 & ⋯ & Pixel p\end{matrix} \\ \begin{matrix}x \\ y \\ z\end{matrix} {( \begin{matrix}* & ⋯ & * \\ * & ⋯ & * \\ * & ⋯ & *\end{matrix} )}_{Matrix product {L}^{- 1} \cdot I} & ( 4 )\end{matrix}$$

$$\begin{matrix}[ Expression 5 ] & \\ \begin{matrix}Pixel 1 & ⋯ & Pixel p\end{matrix} \\ \begin{matrix}x \\ y \\ z\end{matrix} ( \begin{matrix}\frac{{x}_{1}}{{( {x}_{1}^{2} + {y}_{1}^{2} + {z}_{1}^{2} )}^{0.5}} & ⋯ & * \\ \frac{{y}_{1}}{{( {x}_{1}^{2} + {y}_{1}^{2} + {z}_{1}^{2} )}^{0.5}} & ⋯ & * \\ \frac{{z}_{1}}{{( {x}_{1}^{2} + {y}_{1}^{2} + {z}_{1}^{2} )}^{0.5}} & ⋯ & *\end{matrix} ) & ( 5 )\end{matrix}$$

The normal map image is obtained by normalizing the values in the range of the minimum value to the maximum value of the matrix of the above Expression (5) to values in the range of 0 to 255 to obtain (R, G, B)=(x, y, z). In this manner, the first image generating unit 500d can generate the first image 740 that is the normal map image illustrated in FIG. 8 on the basis of the first 3DCG image 710, the second 3DCG image 720, and the third 3DCG image 730 illustrated in FIGS. 5 to 7.

The captured image generating unit 500e generates at least three captured images with different light sources on the basis of at least the first light source 400A, the second light source 400B, and the third light source 400C that illuminate the inspection object 200 and the imaging device 300 that captures an image of the inspection object 200 being illuminated. The at least three captured images include the first captured image, the second captured image, and the third captured image. The first captured image is obtained by capturing an image of the inspection object 200 illuminated by the light emitted from the first light source 400A in the first direction L1 by the imaging device 300. The second captured image is obtained by capturing an image of the inspection object 200 illuminated by the light emitted from the second light source 400B in the second direction L2 by the imaging device 300. The third captured image is an image obtained by imaging the inspection object 200 illuminated by the light emitted from the third light source 400C in the third direction L3 by the imaging device 300.

The second image generating unit 500f generates a second image on the basis of the direction vector n of the surface of inspection object 200 derived on the basis of the at least three captured images generated by the captured image generating unit 500e. Specifically, the second image generating unit 500f generates the second image that is the normal map image on the basis of the direction vector n of the surface of the inspection object 200 derived on the basis of the first captured image, the second captured image, and the third captured image. Similarly to the normal map image as the first image 740, the normal map image as the second image is also derived from the above Expression (2) to Expression (5). In the generation of the second image, the terms used in the generation of the first image 740 are replaced as follows. The “virtual object 600” is replaced with “inspection object 200”. The “first 3DCG image 710” is replaced with “first captured image”. The “second 3DCG image 720” is replaced with “second captured image”. The “third 3DCG image 730” is replaced with “third captured image”. The “first virtual light source 800A” is replaced with “first light source 400A”. The “second virtual light source 800B” is replaced with “second light source 400B”. The “third virtual light source 800C” is replaced with “third light source 400C”. Since the generation method of the second image is similar to the generation method of the first image 740, detailed description thereof will be omitted.

The training data generating unit 500g generates correct data indicating the position of the defect 610 in the first image 740 on the basis of defect information of the defect 610 added by the defect adding unit 500b. Incidentally, the three-dimensional shape data of the defect 610 includes information of coordinates of the defect 610 in the three-dimensional space, and includes position information indicating the position of the defect 610 and depth information indicating the depth. Such information regarding the defect 610 including position information indicating the position of the defect 610 and depth information indicating the depth is also referred to as defect information. The defect adding unit 500b adds the defect 610 to the surface of the virtual object 600 using the three-dimensional shape data including the defect information of the defect 610 stored in the storage device 520. Since the position and the depth distribution of the defect 610 added by the defect adding unit 500b are known, the training data generating unit 500g can generate correct data on the basis of the defect information of the defect 610.

In the correct data, for example, a numerical value “1” is associated with a pixel corresponding to the position of the defect 610 in the first image 740 as an abnormal part. In the correct data, for example, the numerical value of “0” is associated with a pixel corresponding to a position other than the defect 610 in the first image 740 as a normal part.

In the correct data, a numerical value other than “0” in a range of “0” to “1” is associated with each pixel on the basis of the depth distribution at the position of the defect 610 in the first image 740. For example, in the correct data, for a pixel corresponding to the position of the defect 610, a numerical value closer to “1” is associated as the depth of the defect 610 is deeper, and a numerical value closer to “0” is associated as the depth of the defect 610 is shallower.

In the first image 740, the pixel value changes depending on the distance from the imaging surface of the virtual imaging device 700 to the virtual object 600. For example, in first image 740, pixel values are represented by 256 gradations from “0” to “255”. For example, let us presume that the pixel value approaches “0” as the distance from the imaging surface of the virtual imaging device 700 is shorter, and the pixel value approaches “255” as the distance from the imaging surface is longer. Since the pixel values of the first image 740 include distance information regarding the distance from the imaging surface of the virtual imaging device 700, the depth distribution of the defect 610 can be expressed by converting the pixel values.

For example, in the correct data, for a pixel corresponding to the position of the defect 610, a numerical value closer to “1” is associated as the depth of the defect 610 is deeper, that is, as the pixel value is closer to “255”. Furthermore, in the correct data, for a pixel corresponding to the position of the defect 610, as the depth of the defect 610 is shallower, that is, as the pixel value is closer to “0”, a numerical value closer to “0” is associated.

The training data generating unit 500g associates the first image 740 with the correct data, and collectively stores the first image 740 and the correct data in the storage device 520 as training data. In the present embodiment, the training data generating unit 500g generates training data in which the defect information related to the defect 610 including at least the position information and the depth information of the defect 610 is associated with the first image 740. The training data generating unit 500g generates a plurality of pieces of such training data.

Specifically, the 3DCG image generating unit 500c generates a plurality of types of first 3DCG images 710, second 3DCG images 720, and third 3DCG images 730 on the basis of a plurality of types of virtual objects 600 having a wide variety of defects 610. At this point, the 3DCG image generating unit 500c randomly changes parameters of imaging conditions of the virtual imaging device 700 to generate various first 3DCG images 710, second 3DCG images 720, and third 3DCG images 730. The imaging conditions include the surface optical characteristics of the inspection object 200 in the virtual object 600, the direction of the imaging surface of the virtual imaging device 700, the direction of the virtual light source 800, the light intensity of the virtual light source 800, and the like.

Examples of the surface optical characteristics of the inspection object 200 include surface reflectance, diffuse reflectance, surface roughness, and the like. However, changing a parameter of the imaging conditions is not an essential condition, and the 3DCG image generating unit 500c may generate a plurality of types of first 3DCG images 710, second 3DCG images 720, and third 3DCG images 730 on the basis of a plurality of types of virtual objects 600 in which only a parameter of the defect 610 has been changed.

A plurality of pieces of training data can be generated by changing at least the parameter of the defect 610. The training data generating unit 500g stores the plurality of types of generated training data in the storage device 520.

The model learning unit 500h inputs a plurality of types of training data stored in the storage device 520 to an inspection model M, and trains the inspection model M such that output data approximating to correct data included in the training data can be obtained.

The inspection model M of the present embodiment includes, for example, a neural network (NN). The neural network is a convolutional neural network (CNN) trained by supervised learning. However, a neural network other than the convolutional neural network may be used. Alternatively, a learning model other than the neural network may be used.

The inspection model M is, for example, a deep learning model in image analysis. In the present embodiment, the inspection model M includes, for example, a combination of the structure of the neural network and parameters indicating the connection strength between neurons. A parameter, which is a coefficient, is provided one by one at a connection portion between the neurons. Each parameter is adjustable. The internal state of the inspection model M is represented by a set of numerical values that is a combination of the structure of the neural network and parameters between neurons, the set of numerical values called internal variables.

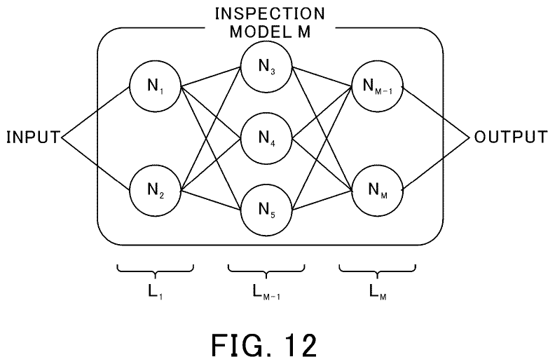

FIG. 12 is a diagram illustrating an example of the inspection model M. As illustrated in FIG. 12, training data is input to the inspection model M, and output data in which a value of 0 to 1 of the output node is associated with each pixel as described above is output by passing through neurons N₁, N₂, N₃, N₄, N₅, N_{M-1}, or N_{M}.

The inspection model M is trained on the basis of training data including the first image 740 associated with correct data in advance. The training data is input to the inspection model M, and the value of the internal variable of the inspection model M is set such that an error between the output data of the inspection model M and the correct data associated with the first image 740 of the training data is reduced. In this manner, the inspection model M is trained on the basis of a plurality of types of training data.

Note that the model learning unit 500h may use the first image 740 to which no correct data is associated as training data. That is, the model learning unit 500h may input the first image 740 to which no correct data is associated to the inspection model M, and train the inspection model M in such a manner as to reduce the error between information indicating the position of the defect 610 output from the inspection model M and the correct data. In this case, the first image generating unit 500d functions as a training data generating unit.

In addition, the model learning unit 500h may use the second image as training data in addition to the first image 740. That is, the model learning unit 500h may input the first image 740 and the second image to the inspection model M, and train the inspection model M in such a manner as to reduce the error between the information indicating the position of the defect 610 output from the inspection model M and the correct data. In this case, the first image generating unit 500d and the second image generating unit 500f function as a training data generating unit.

The estimation detection unit 500i inputs the second image generated by the second image generating unit 500f on the basis of the first captured image, the second captured image, and the third captured image to the inspection model M. At this point, the inspection model M classifies each pixel of the second image, and the defect 210 of the second image, namely, pixels corresponding to the defect 210 are associated with a value larger than “0” among the numerical values “0” to “1” as an output node. In addition, a pixel corresponding to a normal part of the second image is associated with the numerical value of “0” as an output node. In this manner, in the present embodiment, the second image input to the inspection model M is output in an output format of semantic segmentation.

The estimation detection unit 500i estimates the position of the defect 210 of the inspection object 200 included in the second image on the basis of the output data of the inspection model M, namely, the numerical values “0” to “1” as the output nodes, and further estimates the depth of the defect 210. Specifically, the estimation detection unit 500i estimates the position of the pixel associated with the numerical value of the output node other than “0” as the position of the defect 210. Furthermore, the estimation detection unit 500i estimates the depth of the defect 210 depending on the magnitude of the numerical value of the output node other than “0”. In this manner, the estimation detection unit 500i estimates the position and the depth distribution of the defect 210 depending on the position of the pixel to which the numerical value of the output node other than “0” is associated and the magnitude of the numerical value of the output node other than “0”.

The estimation detection unit 500i causes a display (not illustrated) to display information indicating the estimated position of the defect 210 of the inspection object 200 and information indicating the estimated depth of the defect 210 (hereinafter, also referred to as estimation result data).

For example, the estimation detection unit 500i superimposes and displays a predetermined color on the position of the defect 210 with respect to the second image displayed on the display. At this point, the estimation detection unit 500i may superimpose and display the color on the second image displayed on the display while changing the color depending on the depth of the defect 210. For example, the estimation detection unit 500i may superimpose and display color information on the second image such that the deeper the depth of the defect 210 is, the darker the color is, and the shallower the depth is, the lighter the color is.

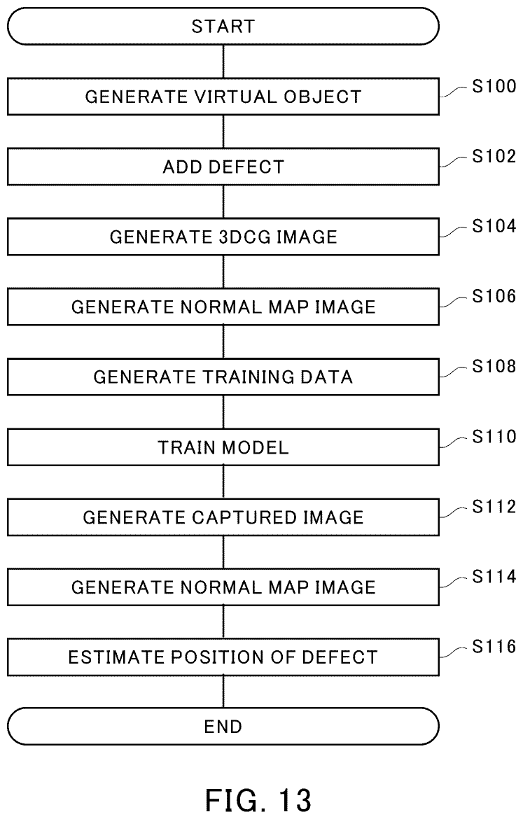

FIG. 13 is a flowchart illustrating an example of a generation method of training data according to the present embodiment. As illustrated in FIG. 13, the 3D graphic model generating unit 500a generates the virtual object 600 in which the three-dimensional shape of the inspection object 200 is represented in the virtual space S on the basis of the three-dimensional shape data of the inspection object 200 (step S100).

The defect adding unit 500b adds the defect 610 to the virtual object 600 (step S102). The 3DCG image generating unit 500c generates at least three 3DCG images with different virtual light sources (step S104). The first image generating unit 500d generates the first image 740, which is a normal map image on the basis of the direction vector n of the surface of the virtual object 600 derived on the basis of at least three 3DCG images (step S106).

The training data generating unit 500g generates training data in which correct data indicating the position of the defect 610 is associated with the first image 740 (step S108). The model learning unit 500h inputs only the training data generated by the training data generating unit 500g to the inspection model M to train the inspection model M (step S110).

The captured image generating unit generates at least three captured images with different light sources (step S112). The second image generating unit 500f generates the second image, which is a normal map image on the basis of the direction vector of the surface of the inspection object 200 derived on the basis of at least three captured images (step S114).

The estimation detection unit 500i inputs the second image, which is a normal map image, to the trained inspection model M, and estimates the position of the defect 210 of the inspection object 200 included in the second image (step S116).

As described above, the image processing device 500 of the present embodiment includes the first image generating unit 500d. The first image generating unit 500d generates the first image 740, which is a normal map image, on the basis of the direction vector n of the surface of the virtual object 600 derived on the basis of at least three 3DCG images having different virtual light sources and captured by the photometric stereo method. The image processing device 500 also includes the second image generating unit 500f. The second image generating unit 500f generates the second image, which is a normal map image, on the basis of the direction vector n of the surface of the inspection object 200 derived on the basis of at least three captured images having different light sources and captured by the photometric stereo method. In addition, the model learning unit 500h inputs the first image 740 to the inspection model M as training data to train the inspection model M. The estimation detection unit 500i further inputs the second image into the trained inspection model M, and estimates the position of the defect 210 of the inspection object 200 included in the second image.

As described above, according to the present embodiment, the first image 740 which is a normal map image is generated by capturing images of the virtual object 600 imitating the inspection object 200 in the virtual space S by the photometric stereo method. The generated first image 740 is used as training data to train the inspection model M. In addition, an image of the actual inspection object 200 is captured in the real space by the photometric stereo method to generate a second image which is a normal map image. The generated second image is input to the trained inspection model M, and the position of the defect 210 of the inspection object 200 included in the second image is estimated. As described above, the first image 740 and the second image input to the inspection model M are the same type of normal map images.

In order to train the inspection model M used for the appearance inspection of the inspection object 200, a large amount of training data, for example, several hundreds to tens of thousands pieces, is required. However, in a case where the inspection object 200 is a general industrial product, it is difficult to obtain a large amount of training data for each inspection object 200 due to the variety of product shapes.

In the present embodiment, the defect adding unit 500b adds the defect 610 to the virtual object 600 imitating the inspection object 200. The defect adding unit 500b changes the parameter of the defect 610 and adds the defect 610 to the virtual object 600, whereby it is made possible to generate a large amount of training data by simulation. Therefore, even in a case where the number of pieces of training data is small, a large amount of training data by simulation can be generated, and thus the inspection model M can be accurately trained.

In addition, even in a case where a large amount of training data can be generated by simulation, there may be a large difference in appearance between an image generated by simulation serving as training data and a captured image captured by the imaging device in the real space. In that case, even when the image generated by simulation is used as training data, there is a problem that the accuracy of the position of the defect in the inspection object estimated by the inspection model trained using the training data is poor.

In the present embodiment, the first image 740 and the second image input to the inspection model M are the same type of normal map images. Therefore, the difference in appearance between the first image 740 and the second image can be reduced, and as a result, the accuracy of the position of the defect 210 of the inspection object 200 estimated by the trained inspection model M can be improved.

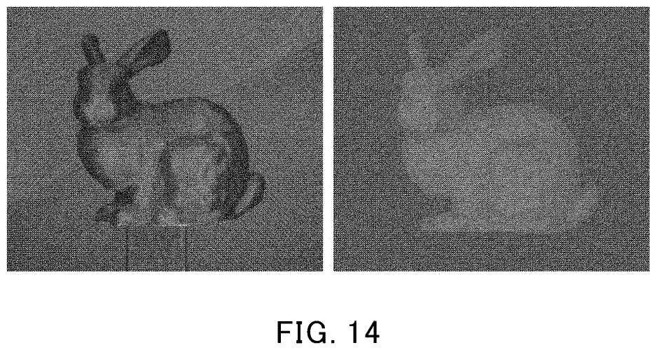

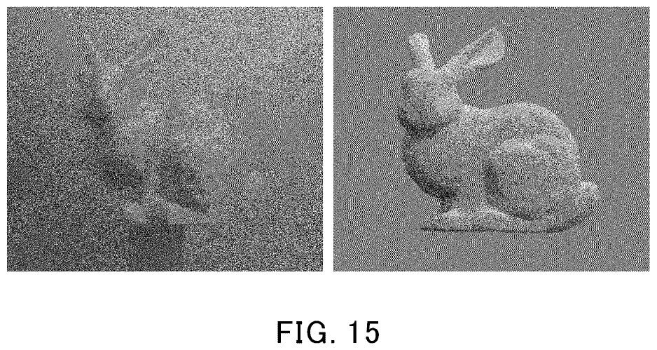

FIG. 14 is a diagram illustrating examples of a captured image obtained by capturing the inspection object 200 with all of the plurality of light sources 400 turned on and a 3DCG image obtained by capturing the virtual object 600 with all of the plurality of virtual light sources 800 turned on. FIG. 15 is a diagram illustrating examples of a normal map image generated by sequentially turning on the plurality of light sources 400 for the inspection object 200 and a normal map image generated by sequentially turning on the plurality of virtual light sources 800 for the virtual object 600.

In FIG. 14, the image on the left side is the captured image obtained by capturing the inspection object 200 with all of the plurality of light sources 400 turned on, and the image on the right side is the 3DCG image obtained by capturing the virtual object 600 with all of the plurality of virtual light sources 800 turned on. In FIG. 15, the image on the left side is the normal map image generated by sequentially turning on the plurality of light sources 400 for the inspection object 200, and the image on the right side is the normal map image generated by sequentially turning on the plurality of virtual light sources 800 for the virtual object 600.

A result of deriving similarity between the captured image and the 3DCG image illustrated in FIG. 14 by the structural similarity (SSIM) was 0.715758. Meanwhile, the result of deriving the similarity between the two normal map images illustrated in FIG. 15 by SSIM was 0.806890. That is, it can be seen that the similarity between the two normal map images illustrated in FIG. 15 is higher than the similarity between the captured image and the 3DCG image illustrated in FIG. 14. Therefore, according to the present embodiment, it is possible to reduce the difference in appearance between normal map images of the same type as compared with a case where the captured image captured by the imaging device 300 and the 3DCG image captured by the virtual imaging device 700 are used as they are.

Furthermore, according to the present embodiment, when the inspection model M is trained, the second image generated on the basis of at least three captured images captured by the imaging device 300 can be used as training data in parallel with the training data of the first image 740. Since the second image is generated by the captured image obtained by capturing the actual inspection object 200 in the real space, the inspection model M can be caused to learn the shape of the defect 210 actually formed in the inspection object 200. As a result, the accuracy of the position of the defect 210 of the inspection object 200 estimated by the trained inspection model M can be improved.

In addition, according to the present embodiment, when the inspection model M is trained, training data in which correct data indicating the position of the defect 610 is associated with the first image 740 is used. As a result, the accuracy of the position of the defect 610 estimated by the inspection model M can be improved.

Although the embodiment has been described with reference to the accompanying drawings, the present disclosure is not limited to the above embodiment. It is clear that those skilled in the art can conceive various modifications or variations within the scope described in the claims, and it is understood that they are naturally also within the technical scope of the present disclosure.

The present disclosure can, for example, contribute to Goal 12 “Ensure sustainable consumption and production patterns” of the Sustainable Development Goals (SDGs).

1. A generation device comprising:
a virtual object generating unit that generates a virtual object representing a three-dimensional shape of an inspection object in a virtual space on a basis of three-dimensional shape data of the inspection object;
a defect adding unit that adds a defect to the virtual object;
a 3DCG image generating unit that generates at least three 3DCG images with different virtual light sources on a basis of the virtual object to which the defect has been added, at least three virtual light sources that illuminate the virtual object to which the defect has been added, and a virtual imaging device that captures an image of the virtual object being illuminated; and
a first image generating unit that generates a first image as training data on a basis of a direction vector of a surface of the virtual object derived on a basis of the at least three 3DCG images.

2. The generation device according to claim 1, further comprising:
a captured image generating unit that generates at least three captured images with different light sources on a basis of the inspection object, at least three light sources that illuminate the inspection object, and an imaging device that captures an image of the inspection object being illuminated; and
a second image generating unit that generates a second image as the training data on a basis of a direction vector of a surface of the inspection object derived on a basis of the at least three captured images, wherein
the three light sources are arranged at positions corresponding to positions of the three respective virtual light sources.

3. The generation device according to claim 1, wherein
the training data is data in which correct data indicating a position of the defect is associated with the first image.

4. A generation method comprising the steps of:
generating a virtual object representing a three-dimensional shape of an inspection object in a virtual space on a basis of three-dimensional shape data of the inspection object;
adding a defect to the virtual object;
generating at least three 3DCG images with different virtual light sources on a basis of the virtual object to which the defect has been added, at least three virtual light sources that illuminate the virtual object to which the defect has been added, and a virtual imaging device that captures an image of the virtual object being illuminated; and
generating a first image as training data on a basis of a direction vector of a surface of the virtual object derived on a basis of the at least three 3DCG images.
